(19) United States
(12) Patent Application Publication
(10) Pub. No.: US 2003/0057945 A1
(43) Pub. Date: Mar. 27, 2003

(54) Method for analysing a sample

(76) Inventors: Nadim Joni Shah, Juelich (DE); Karl Zilles, Koln (DE)

Correspondence Address: CONNOLLY BOVE LODGE & HUTZ, LLP, 1220 N MARKET STREET, P O BOX 2207, WILMINGTON, DE, 19899

(21) Appl. No.: 10/169,341

(22) PCT Filed: Dec. 20, 2000
(86) PCT No.: PCT/DE00/04642

(30) Foreign Application Priority Data
Dec. 24, 1999 (DE) 199 62 476.3

(51) Int. Cl. G01V 3/00

(52) U.S. Cl. 324/307; 324/309; 324/312

(57) ABSTRACT

The invention relates to a method for analysing a sample. According to said method, the sample is irradiated by at least one excitation pulse and several rephasing pulses, in such a way that echo signals are generated and determined. The inventive method is characterised in that all echo signals are encoded with a substantially identical phase position and that the exposure sequence is then repeated at least once.

The invention relates to a method to examine a specimen, whereby at least one excitation pulse and several rephasing pulses are emitted onto the specimen so that echo signals are created and ascertained.

The term “specimen” in the case at hand is meant in its broadest sense and encompasses living as well as non-living matter.

Various methods are already known with which a specimen is examined by means of an excitation pulse and several rephasing pulses.

In the method of this type, the specimen is excited by electromagnetic radiation with energy that is suitable for such an excitation.

Examples of methods of this type are light spectroscopy or the examination of specimens by means of neutrons.

It is a known procedure in nuclear magnetic resonance tomography to obtain information about a given specimen by means of the excitation of echo signals of the specimen.

In nuclear magnetic tomography, the method of this type is preferably employed to obtain spectroscopic information or image information about a given substance. A combination of nuclear magnetic resonance tomography with the techniques of magnetic resonance imaging (MRI) provides a spatial image of the chemical composition of the substance.

Magnetic resonance imaging is, on the one hand, a tried and true imaging method that is employed clinically worldwide. On the other hand, magnetic resonance imaging constitutes a very important examination tool for industry and research outside the realm of medicine as well. Examples of applications are the inspection of food products, quality control, pre-clinical testing of drugs in the pharmaceutical industry or the examination of geological structures, such as pore size in rock specimens for oil exploration.

The special strength of magnetic resonance imaging lies in the fact that very many parameters have an effect on nuclear magnetic resonance signals. A painstaking and controlled variation of these parameters allows experiments to be performed that are suitable to show the influence of the selected parameter.

Examples of relevant parameters are diffusion processes, probability density distribution of protons or a spin-lattice relaxation time.

In nuclear resonance tomography, atom nuclei having a magnetic momentum are oriented by a magnetic field applied from the outside. In this process, the nuclei execute a precession movement having a characteristic angular frequency. (Larmor frequency) around the direction of the magnetic field. The Larmor frequency depends on the strength of the magnetic field and on the magnetic properties of the substance, particularly on the gyromagnetic constant γ of the nucleus. The gyromagnetic constant γ is a characteristic quantity for every type of atom. The atom nuclei have a magnetic momentum μ=γ×p wherein p stands for the angular momentum of the nucleus.

In nuclear resonance tomography, a substance or a person to be examined is subjected to a uniform magnetic field. This uniform magnetic field is also called a polarization field B₀ and the axis of the uniform magnetic field is called the z axis. With their characteristic Larmor frequency, the individual magnetic momentums of the spin in the tissue precede around the axis of the uniform magnetic field.

A net magnetization M_{z} is generated in the direction of the polarization field, whereby the randomly oriented magnetic components cancel each other out in the plane perpendicular to this (the x-y plane). After the uniform magnetic field has been applied, an excitation field B₁ is additionally generated. This excitation field B₁ is polarized in the x-y plane and it has a frequency that is as close as possible to the Larmor frequency. As a result, the net magnetic momentum M_{z} can be tilted into the x-y plane so that a transverse magnetization Mₜ is created. The transverse component of the magnetization rotates in the x-y plane with the Larmor frequency.

By varying the time of the excitation field, several temporal sequences of the transverse magnetization Mₜ can be generated. In conjunction with at least one applied gradient field, different slice profiles can be realized.

Particularly in medical research, there is a need to acquire information about anatomical structures, about spatial distributions of substances as well as about brain activity or, in the broader sense, about blood flow or changes in the concentration of deoxyhemoglobin in the organs of animals and humans.

Magnetic resonance spectroscopy (MRS) makes it possible to measure the spatial density distribution of certain chemical components in a material, especially in biological tissue.

Rapid magnetic resonance imaging (MRI), in conjunction with magnetic resonance spectroscopy (MRS), allows an examination of local distributions of metabolic processes. For instance, regional hemodynamics involving changes in the blood volumes and blood states as well as changes in the metabolism can be determined in vivo as a function of brain activity; in this context, see S. Posse et al.: Functional Magnetic Resonance Studies of Brain Activation; Seminars in Clinical Neuropsychiatry, Volume 1, No. 1, 1996; pages 76 to 88.

An experimental study of hemodynamics is presented in “The variability of human BOLD hemodynamic responses” by Aguirre in NeuroImage, 1998, Vol. 8(4), pages 360-369, also in “Neuronal and hemodynamic responses from functional MRI time-series: A commutational model” by J. Rajapakse, F. Kruggel, D. Y. von Cramon, in “Progress in Connectionist-Based Information Systems (ICONIP '97)” by N. Kasabov, R. Kozma, K. Ko, R. O'Shea, G. Coghill, T. Gedeon, Eds., pages 30-34, Springer, Singapore, 1997 and in “Modeling Hemodynamic Response for Analysis of Functional MRI Time-Series” by Jagath C. Rajapakse, Frithjof Kruggel, Jose M. Maisog and D. Yves von Cramon; Human Brain Mapping 6:283-300, 1998 with suggested Gauss and Poisson functions.

NMR imaging methods select slices or volumes that yield a measuring signal under the appropriate emission of high-frequency pulses and under the application of magnetic gradient fields; this measuring signal is digitized and stored in a one-dimensional or multi-dimensional field in a measuring computer.

A one-dimensional or multi-dimensional Fourier transformation then acquires (reconstructs) the desired image information from the raw data collected.

A reconstructed tomograph consists of pixels, and a volume data set consists of voxels. A pixel (picture element) is a two-dimensional picture element, for instance, a square. The image is made up of pixels. A voxel (volume pixel) is a three-dimensional volume element, for instance, a right parallelpiped. The dimensions of a pixel are in the order of magnitude of 1 mm², and those of a voxel are in the order of magnitude of 1 mm³. The geometries and extensions can vary.

Seeing that, for experimental reasons, it is never possible to assume a strictly two-dimensional plane in the case of tomographs, the term voxel is often employed here as well, indicating that the image planes have a certain thickness.

Functional nuclear magnetic resonance makes it possible to detect dynamic changes and thus to observe processes over the course of time.

With functional magnetic resonance imaging (MRI), images are generated that contain the local changes.

It is also a known procedure to employ functional nuclear magnetic resonance, that is to say, functional nuclear magnetic resonance imaging, to examine neuronal activation. Neuronal activation is manifested by a increase of the blood flow into activated regions of the brain, whereby a drop occurs in the concentration of deoxyhemoglobin. Deoxyhemoglobin (DOH) is a parmagnetic substance that reduces the magnetic field homogeneity and thus accelerates signal relaxation. Oxyhemoglobin displays a magnetic susceptibility corresponding essentially to the structure of tissue in the brain, so that the magnetic field gradients are very small over a boundary between the blood containing oxyhemoglobin and the tissue. If the DOH concentration decreases because of a brain activity that triggers an increasing blood flow, then the signal relaxation is slowed down in the active regions of the brain. It is primarily the protons of hydrogen in water that are excited. The brain activity can be localized by conducting an examination with functional NMR methods that measure the NMR signal with a time delay (echo time). This is also referred to as susceptibility-sensitive measurement. The biological mechanism of action is known in the literature under the name BOLD effect (Blood Oxygenation Level Dependent effect) and, in susceptibility-sensitive magnetic resonance measurements at a field strength of a static magnetic field of, for example, 1.5 tesla, it leads to increases of up to about 5% in the image brightness in activated regions of the brain. Instead of the endogenous contrast agent DOH, other contrast agents that cause a change in the susceptibility can also be used.

The prior-art methods require preliminary examinations in order to acquire correction data for the images.

The invention is based on the objective of developing a method of this type in which data is acquired that is structured in such a way that it allows at least some external influences to be eliminated.

This objective is achieved according to the invention in that all of the echo signals within one imaging sequence are encoded with the same phase position and in that, subsequently, the imaging sequence is repeated at least once.

In this context, it is particularly advantageous for the echo signals to be rearranged in such a manner that echo signals that were taken at an identical time T_{E} are presented as an image.

Moreover, in order to take an image in the form of an N×N matrix, it is practical for the imaging sequence to be repeated N times.

It is likewise practical to carry out the method in such a way that the image of the N×N matrix echo signals corresponds to the sequence [SE (1,1), SE (1,2), SE (1,3), . . . SE (1,N)].

The imaging method is preferably a spectroscopic echo-planar imaging method, especially a repeated two-dimensional echo-planar imaging method, consisting of the repeated application of two-dimensional echo-planar image encoding.

Spatial encoding takes place within the shortest possible period of time, which is repeated multiple times during a signal drop, preferably amounting to 20 ms to 100 ms.

The multiple repetition of the echo-planar encoding serves to depict a course of the signal drop in the sequence of reconstructed individual images during a signal drop.

The relaxation time T₂ is quantified by means of several images that are taken at different echo times. At a given matrix size, the number of images is limited as a function of the properties of the measuring equipment and the value of T₂. Therefore, in order to generate quantitative images, the data has to be adapted on the basis of a limited number of data points that are possibly noise-infested.

Additional advantages, special features and practical refinements of the invention can be found in the subordinate claims and in the presentation below of a preferred embodiment of the invention making references to the drawing.

The drawing shows a sequential diagram of a preferred embodiment of a method according to the invention.

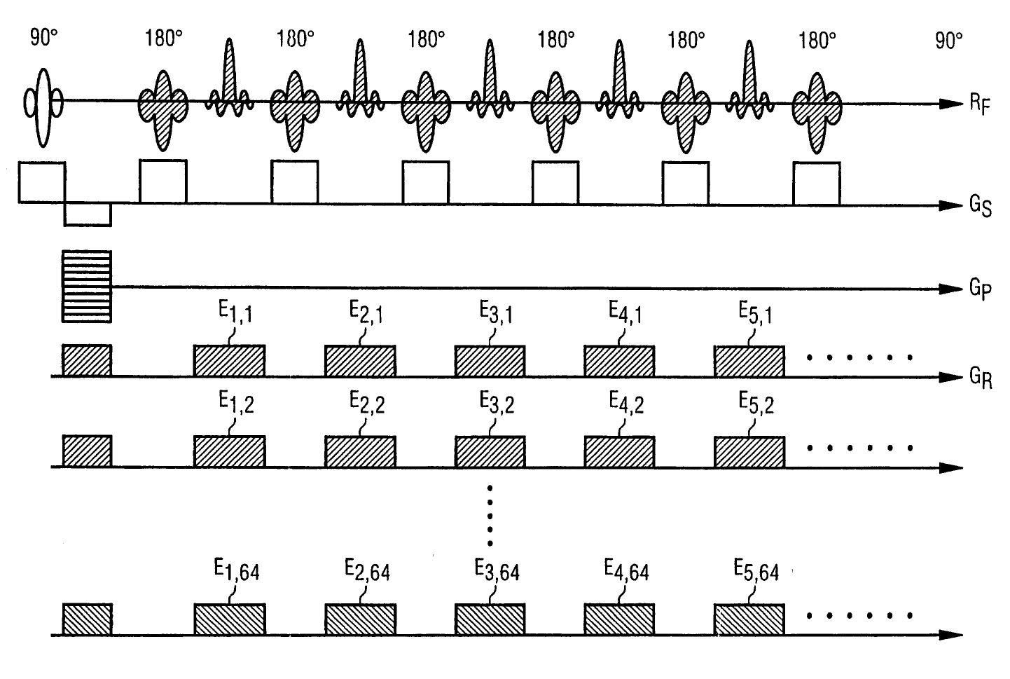

FIG. 1 depicts different components of the sequence over time one above the other. Individual lines that extend in the horizontal plane represent the time dependence of individual parameters. The individual parameters are arranged above each other in such a way that simultaneous occurrences are found directly one above the other.

In the top line, the applied or resultant field RF is shown in a line that reflects the time-dependence of the field and that corresponds to a pulse sequence.

Below the line that depicts the time dependence of the field, there are three lines that reflect the time-dependence of the gradient fields G_{S}, G_{P} and G_{R}.

The first gradient field G_{S} preferably extends in a main direction of a uniform magnetic field B₀. This magnetic field B₀ is also called a polarization field and the axis of the uniform magnetic field is call the z axis. A slice of the specimen to be examined is selected through the gradient field G_{S}. This is why the gradient field G_{S} is also called the slice-selection gradient. In order to be able to better distinguish the various gradients from each other, the designation G_{S} will be employed below for the slice-selection gradient.

Below the first gradient G_{S}, an additional gradient field is shown that corresponds to a phase-encoding gradient G_{P}. This phase-encoding gradient G_{P} preferably lies along a y axis and it serves to select lines of a pulse space that is to be examined.

Below the other gradient field, a third gradient field is shown that corresponds to a read-out gradient G_{R}. This read-out gradient G_{R} preferably lies along an x axis and it serves to read out signals, especially echo signals, of a specimen that is to be examined. In order to allow a reproduction of the signals in the form of an image, several imaging sequences—shown in FIG. 1 one above the other—are carried out with the read-out gradient G_{R}.

Going into more detail, the method is carried out as follows:

First of all, a net magnetization of the specimen to be examined is excited by means of an excitation pulse, preferably a 90° pulse, shown on the left-hand side of the top line. This excitation pulse has a duration of, for instance, 1 to 10 milliseconds, whereby particular preference is given to a duration of 2 to 3 milliseconds.

While the specimen to be examined is being excited by the excitation pulse, a slice-selection gradient G_{S} is applied to the specimen, thus causing a partial dephasing of the transverse magnetization.

Following the excitation pulse, the spins are once again rephased by means of an another slice-selection gradient G_{S} having a changed sign.

Here, a time integral of the other slice-selection gradient G_{S} is preferably half that of the time integral of the first slice-selection gradient G_{S} that is applied during the excitation pulse. As a result, the other slice-selection gradient G_{S} functions as a rephasing gradient.

Subsequently, a rephasing pulse, preferably a 180° pulse, is emitted. It is practical for the rephasing pulse to be emitted so as to be phase-offset by 90° relative to the excitation pulse. In order to select a slice, the slice-selection gradient G_{S} is applied once again, preferably at the same time. In particular, this slice is the same slice as before.

A first echo signal is observed after the first rephasing pulse.

This first echo signal is detected.

This is followed by another rephasing pulse after which, in turn, an echo signal is generated and measured.

The sequence of the field shown in the top line continues until it corresponds to a desired number of scanning points of a T₂ relaxation curve.

Following the above-mentioned first imaging sequence, the method is repeated as often as the number N_{y} of lines corresponds to a desired (N_{y}×Nₓ) image matrix.

In the simplest case, in which an area to be examined is to be depicted as an N×N) matrix, each imaging sequence contains N excitation pulses. In this case, the imaging sequence is repeated N times.

While the axes shown in FIG. 1 are time axes, the actual image encoding takes place along the columns. The number of rephasing pulses is preferably the same as the desired number of scanning points of the T₂ relaxation curve.

The number of repetitions presented is practical although not necessary.

The invention involves suppressing artifacts by means of an essentially identical phase position between different imaging sequences.

The invention makes it possible to rearrange echo signals. This ensures that only echo signals that correspond to a desired echo time T_{B} are depicted in a desired plane of the pulse space. This avoids a convolution of the signal with a T₂ drop function. This is particularly advantageous when the pulse space is traversed from area that lie far outside, through central areas, and then to areas that lie outside, opposite from the first areas. In this manner, it is achieved that the spatial resolution remains high in the entire pulse space.

Data corresponding to the central areas of the pulse space and encoded with a 0 phase can be employed to perform a phase correction of the measured data stemming from other imaging sequences. This avoids the need for preliminary measurements of the specimens to be examined.

It is advantageous to suppress the lipid signals. Preference is given to using a frequency-selective lipid presaturation.

The invention can also be deployed in other realms, such as light spectroscopy or to examine specimens by means of neutrons.

1. A method to examine a specimen, whereby at least one excitation pulse and several rephasing pulses are emitted so that echo signals are created and ascertained, whereby all of the echo signals within one imaging sequence are encoded with essentially the same phase position, whereby subsequently, the imaging sequence is repeated at least once, characterized in that the echo signals are rearranged in such a manner that echo signals that were taken at an identical time T_{B} are presented as an image and in that a slice-selection gradient is applied once again, so that the same slice as before is selected.

2. The method according to one or more of the preceding claims, characterized in that, in order to take at least one image in the form of an N×N matrix, the imaging sequence is repeated N times.

3. The method according to claim 3, characterized in that echo signals are detected in a sequence [SE (1,1), SE (1,2), SE (1,3), . . . SE (1,N)] in the image of the N×N matrix.

4. The method according to one or more of the preceding claims, characterized in that the encoding takes place within a period of time ranging from to 20 ms to 100 ms.

5. The method according to one or more of the preceding claims, characterized in that the imaging sequence is repeated as often as the number N_{y} of lines corresponds to a desired (N_{y}×Nₓ) image matrix.
